(19) United States
(12) Patent Application Publication
(10) Pub. No.: US 2026/0339670 A1
(43) Pub. Date: Oct. 29, 2026

(54) METHOD AND AN APPARATUS FOR AN EFFICIENT TAG FORWARDING FOR MEMORY POINTER INCREMENT IN A CHERI ENABLED CPU

(71) Applicant: Codasip, s.r.o., Brno (CZ)

(72) Inventor: Tariq Kurd, Bristol (GB)

(21) Appl. No.: 19/187,391

(22) Filed: Apr. 23, 2025

(51) Int. Cl. G06F 9/38

(52) U.S. Cl. CPC G06F 9/3842; G06F 9/3861; G06F 9/3867

(57) ABSTRACT

A method and a system embodying the method for an efficient capability verification tag forwarding for a Capability Hardware Enhanced RISC Instructions (CHERI) enabled Central Processing Unit, comprising: executing an instruction manipulating an address of a source capability resulting in a destination capability in a first clock cycle; speculatively forwarding the capability verification tag of the destination capability in the first clock cycle; verifying an integrity of the destination capability's address in a second clock cycle; starting execution of a second instruction in the second clock cycle in parallel with the verifying; and reevaluating the status of the speculatively forwarded the capability verification tag in response to the verifying is disclosed.

### BACKGROUND

### 1. Field

The present invention relates to processor design. More particularly, this invention is directed toward an efficient hardware tag forwarding method and apparatus for memory pointer incrementing in a Capability Hardware Enhanced RISC Instructions (CHERI) enabled Central Processing Unit (CPU).

### 2. Description of Related Technology

The design of memory safety in the mainstream processors'CPU is prone to security problems, either via errors in code written in memory-unsafe programming languages such as C and C++ or even in code written in memory-safe programming languages such as Rust since not all memory safety vulnerabilities can be detected by the compiler. Other security problems stem from exploit attempts, e.g., targeting buffer overruns, Return-oriented-programming (ROP), jump-oriented programming (JOP), and other exploit attempts known to a person of ordinary skill in the art.

Instructions executed on a CPU uses integer numbers as pointers, consequently manipulating a pointer is typically accomplished by simple mathematical operations on the pointer and optionally another integer representing an offset. A pointer to any addressable memory to be accessed can be manipulated in any manner, limited only by the programming language or the Instruction Set Architecture. By means of an example the C and C++ languages allow mathematical operations on a pointer to be multiplication by a value, division by a value, subtraction of a value from the pointer, addition of a value to the pointer and other operations known to a person of ordinary skill in the art. Even considering memory-safe programming languages, not all memory safety vulnerabilities can be detected.

Referring to FIG. 1, which illustrates a typical scenario when accessing memory. A program's instruction 102, being executed by a Central Processing Unit (CPU) (not shown), causes the CPU to fetch a stack pointer 104 (SP), i.e., a pointer storing a memory address of the topmost element in the stack frame held in a register, together with at least one parameter 106, i.e., value(s) by which to adjust the SP 104 by on stack frame allocation or deallocation provided by a currently executing program. The memory address comprises a physical address, should the operating system disable address translation, or a virtual address should the operating system enable address translation. To prevent unnecessary complication, for the purpose of this application, the virtual address is used by means of an example. The SP 104 and the at least one parameter 106 are provided to the arithmetic logic unit (ALU) 108, which performs addition of the SP 104 and the at least one parameter 106, yielding a destination stack pointer 108 (DSP). As depicted for the purposes of the explanation, the DSP 108 stores a virtual address and the result of the addition may also be referred to as a destination virtual address. The ALU 108 then provides the destination virtual address together with an offset 112, which specifies the offset between the destination virtual address and the actual (L/S) address to access within the stack frame provided by the currently executing program, to the address generation unit (AGU) 114. Such offset 112 can be fetched by the CPU from a register, or be represented by an Incremental Immediate field (Imm) encoded within the instruction 102. This processing is usually implemented in a single clock cycle.

Upon receiving the destination virtual address, the AGU 114 calculates the load or store (L/S) virtual address, and provides the L/S virtual address to a load/store unit (LSU) 116. Although the AGU 114 and the LSU 116 are depicted as separate units, such a configuration is implementation dependent, thus in some implementations the AGU 114 and the LSU 116 constitute a single unit. This processing is usually implemented in a single clock cycle.

The LSU 116 comprises a Data Translation Lookaside Buffer (DTLB) 118, a cache tag (CT) 120 buffer, and a memory protection unit (MPU) 122. The DTLB 108 comprises a translation buffer that stores the recent translations, i.e., virtual to physical mappings for the upper address bits, permissions, e.g., read/write/execute, and attributes, as a series of entries. The CT 120 stores the upper virtual and physical address bits of all lines in the cache, the valid bit to show if the entry is valid, and the dirty bit to show whether the cache line has been written to and so must be written back to main memory if evicted. The MPU 122 contains information of the physical memory/memories existing in the system, e.g., cached memory, device memory, and other memories known to a person of ordinary skill in the art, and definition of a finite number of ranges which can be individually configured to enforce access permissions to a range of addresses of the physical memory in the system.

Upon receiving the virtual address, the LSU 116 performs checks on the virtual address according to the permissions, and should the additional checks succeed, translates the provided virtual memory address to the physical memory address. The DTLB 118 then returns the physical address, the CT 120 returns information whether the line hit in the cache, and should there have been a hit, either the virtual or physical address addresses the data in one or more random address memories (RAMs) (not shown), which return the data. Should there have been a DTLB 118 miss, a secondary page table (not shown) is typically accessed to look up the corresponding page, and if that also misses then a page-table walk is required.

Should the additional checks fail, the DTLB 118 generates an exception for further processing (not shown). The CPU invokes an exception handler and aborts the currently executing program.

Based on the foregoing, a memory address corruption or exploit may happen whenever an instruction executed by a program accidentally or maliciously overwrites or overreads a memory to which the program should have no access.

Consequently, improvements in memory safety became desirable. One such improvement effort resulted in a Capability Hardware Enhanced RISC Instructions (CHERI) project, a joint research project of SRI International and the University of Cambridge, revisiting fundamental design choices in hardware and software to dramatically improve system security. CHERI extends conventional hardware Instruction-Set Architectures (ISAs) with new architectural features to enable fine-grained memory protection and highly scalable software compartmentalization.

Although the term CHERI, indicates a RISC CPU architecture specification, there is also a CHERI RISC-V proposed standard for CPU architecture (current version 0.9.5), and even a version for a Complex Instruction Set Computers (CISC) CPU architecture. Therefore, any reference to a CHERI extension to the CPU architecture is meant to indicate any such CHERI specification or standard requiring a verification of an address created by a specialized instruction.

The CHERI extension to the CPU supports extra memory security features, most notably via “capabilities”, i.e., bit structures, containing all the information required to identify and authorize access to a region of memory, either virtual or physical, that can help to identify and prevent flaws such as the above-mentioned errors in code, buffer overruns, and other memory exploits, before they become security problems. The capabilities'bit structure comprises several fields, e.g., an address field, which stores an address, i.e., a pointer, and metadata, i.e., bounds, permissions and other information associated with the address. In addition to the metadata, which can be arbitrarily modified by the operating system, every capability also has a hardware managed capability verification tag which indicates whether the capability is valid for use, primarily for memory dereferencing.

To prevent memory address corruption or exploit, CHERI has defined a limited set of specialized instructions that are allowed to manipulate the address field of a capability. The CHERI specifications may add more such instructions in the future, furthermore an end user can add self-defined instructions. Consequently, any instructions that is allowed to manipulate the address field of the capability is contemplated.

Based on the foregoing, before a capability retrieved from a register, whether formed initially upon a program reset or by an instruction, can be provided for use, i.e., further processing or storage, a CHERI specification or a standard specifies that certain instructions using the capability may request that test(s) whether the capability was correctly formed and correctly retrieved, and is sealed, i.e., not permitted to be modified by software, must be performed. Such test(s) may comprise, e.g., whether bounds are malformed, whether reserved bits are set, whether the capability is sealed, and other such test(s) known to a person of ordinary skill in the art. Failure of any of the test(s) result in the capability verification tag, if previously set, being cleared. Regardless of whether the test(s) fail or succeed, the instruction may still proceed with manipulating the address of the capability. All the tests are computationally trivial.

The capability comprising an address (referred to as an old address), which is being manipulated by such instructions may be referred to as source capability, the capability comprising an address (referred to as a new address), resulting from such manipulation may be referred to as a destination address, when an absence of such modifier(s) could cause a confusion. When manipulating the address in the address field by any such instructions, it is necessary to test that the address field of the destination capability doesn't violate the rules of the source capability metadata, as a joint encoding scheme is using the capability's metadata and address to define the bounds and it is required by CHERI that the bounds decoded from the old and new addresses are identical for the manipulation to be valid.

As disclosed supra, one such test validates whether a new address is within the representable range. The metadata and the address field within the source capability define such a representable range comprising an upper and lower limit of addresses within the address field that can be represented without the destination capability becoming invalid. If the new address lies within the representable range, the destination capability is valid for use, for example the address can be dereferenced by an offset. If the new address falls outside the representable range, then the destination capability verification tag is cleared, and so the capability cannot be used.

An alternative to the representable range test is a bounds test. The metadata and the address within the source capability define two memory bounds, a base address bound and a top address bound. If the new address falls outside these memory bounds, then the destination capability verification tag is cleared, and so the capability cannot be used.

A CHERI specification may require a representable range test, bounds test, or a future release may add other tests to enforce the integrity of the capability's address. Consequently, a person of ordinary skill in the art will understand that the instant application uses the representable range test as an example and any test is thus contemplated.

As known to a person of ordinary skill in the art, the instructions allowed to manipulate the address field of a capability are applicable to any memory pointer, e.g., a stack pointer, a pointer to a video frame buffer, a pointer to a Universal Asynchronous Receiver/Transmitter (UART), and any other memory pointers that the address field contains. Consequently, a person of ordinary skill in the art will understand the concept of the description using a CHERI Capability Stack Pointer (CSP) is used as an exemplary description, and is applicable to any such memory pointer.

Since all the instructions allowed to manipulate the address field of a capability carry similar functionality, i.e., manipulating the address of the capability, followed by testing that the address doesn't violate the rules for the current capability metadata, e.g., representable range, bounds verification, or other potential tests for integrity of the destination capability address, the following description uses a CHERI RISC-V CADDI instruction as a representative. Consequently, a person of ordinary skill in the art will understand the concept of the description is applicable to any of the instructions.

To avoid potential obfuscation of the problem by introducing unnecessary complexity, it is assumed for the remainder of this “Description of Related Technology” section that the source capability verification tag is set, the bounds are not malformed, no reserved bits are set, and the capability is unsealed.

Referring to FIG. 2, a program's CADDI instruction (not shown), being executed by a CPU (not shown), causes the CPU to fetch from a register a source capability 200, an address field of which contains a stack pointer (CSP), i.e., an address in a source capability, which is a pointer to the topmost element in the stack. The CSP together with at least one parameter 202, i.e., value(s) by which to modify the CSP on stack frame allocation or deallocation provided by the currently executing program, are provided to the arithmetic logic unit (ALU) 204, which performs an addition of the address of the source capability 200 and the at least one parameter 202, yielding an address of a destination capability 206. To verify that that the destination capability 206 was correctly formed, and is not sealed, the above-described tests are performed. Regarding specifically the representable range verification, the address of the destination capability 206 is within the representable range of the source capability 200, the source capability 200 is decoded to calculate the representable range from the metadata field of the source capability in block 208. The destination capability 206 and the source capability 200, are provided for a verification to a representable permission block 210.

The representable permission block 210 verifies whether the virtual address of the destination capability 206 is within the representable range of the source capability 200. Should the verification succeed, the capability verification tag is propagated, i.e., the destination capability 206 includes the capability verification tag of the source capability 200. Should any of the tests including the representable range verification fail, the capability verification tag is cleared, i.e., the destination capability 206 includes a different capability verification tag than the source capability. A capability is (typically) considered to be a single datatype, i.e., being jointly encoded wherein some bits of the address are used with the metadata to decode the address bounds. Therefore, the destination capability 206 cannot be forwarded from the representable permission block 210, until the representable range verification has completed and, therefore, the capability verification tag value is known. The term forwarding a capability, known as forwarding a capability verification tag, is understood as making the capability with a verified capability verification tag available for use by another instruction which reads the capability as soon as possible, e.g., before the capability is written back to a register.

The above-described operations of representable range verification test, as well as bounds verification, or other potential tests for integrity of the destination capability address as described supra, and hardware tag propagating or clearing may take time longer than a single clock cycle, thus requiring either reduction of the clock frequency of the central processing unit (CPU) to extend the clock cycle or an addition of an extra clock cycle before forwarding the destination capability. Consequently, this representable range verification, slows the basic operations of pointer increments and any subsequent CHERI instruction(s) using the result of the destination capability as an input. For the purpose of the following description, the L/S instruction is used.

For consistency with the conceptual structure and information flow of FIG. 1, consider that a second instruction (not shown), is a L/S instruction. The L/S instruction takes as input the destination capability 206 provided by the representable permission block 210 and an offset 212 i.e., a pointer specifying an offset between the destination capability address and the actual L/S address to access, the offset 212 being provided by the currently executing program or being encoded in the L/S instruction. The L/S instruction causes an address generation unit (AGU) 214 to calculate the L/S virtual address from the address of the destination capability 206 and the offset 212. In one aspect, the AGU 214 replaces the address in the destination capability 206 with the L/S virtual address and provides the resulting destination capability 206 to a LSU 216. In another aspect, the AGU 214 provides the L/S virtual address to the LSU 216. The AGU 214 operation occurs in a single clock cycle.

The LSU 216 comprises a Data Translation Lookaside Buffer (DTLB) 218, a cache tag (CT) 220 buffer with a structure as described supra, a memory protection unit (MPU) 222, and a CHERI checker 224. For any CPU, the MPU 222 comprises physical memory attributes (PMA) unit and a physical memory protection (PMP) unit. The PMA unit contains information of the physical memory/memories existing in the system, e.g., cached memory, device memory, and other memories known to a person of ordinary skill in the art. The PMP unit, optional for the CHERI enabled CPU, defines a finite number of regions, which can be individually configured to enforce access permissions to a range of addresses of the physical memory in the system. The CHERI checker 224 performs checks on a capability, e.g., whether the L/S virtual address is in-bounds, the value of the capability verification tag, and other checks known to a person of ordinary skill in the art.

Upon receiving the destination capability 206 and the L/S virtual address from the AGU 214, the CHERI checker 224 performs a check of the destination capability verification tag, checks that all bytes of the access, wherein the lowest byte of the access comprises the L/S virtual address, are within bounds of the destination capability 206, and checks the destination capability 206 permissions. Should the capability verification tag be cleared, due to the failure of representability verification of the address of the source capability 200 during the execution of the CADDI instruction, the CHERI checker 224 aborts the processing of the other structures of the LSU 216 and generates an exception. Should the capability verification tag be set by the CADDI instruction, the CHERI checker 224 performs the remaining capability checks, and if any of them fail, the CHERI checker 224 aborts the processing of the other structures of the LSU 216 and generates an exception. The exception causes the CPU to jump to the exception handler and typically change privilege level. The exception handler performs a process specified by the CPU architecture for the specific instruction and exception type, i.e., the L/S instruction as described and the reason for the exception being capability verification tag failure.

Should all the CHERI checker 224 checks succeed, the LSU 216 other structures perform their relevant checks and process the destination capability 206 according to the result of the checks as known to a person of ordinary skill in the art.

Since slowdown of basic operations of pointer increments and any consequent instructions, e.g., the L/S instruction, has negative impact on the speed of the CHERI enabled CPU, there is a need in the art for an improved tag forwarding method and system for CHERI memory pointer increment.

Based on the foregoing, there is a need to provide a solution to the above identified problem of pointer increment slowdown, as well as additional advantages.

### SUMMARY

In an aspect of the disclosure, an apparatus and a method for an efficient hardware tag forwarding for CHERI memory pointer increment according to appended independent claims is disclosed. Additional aspects are disclosed in the dependent claims.

### BRIEF DESCRIPTION OF THE DRAWINGS

The foregoing aspects described herein will become more readily apparent by reference to the following description when taken in conjunction with the accompanying drawings wherein:

FIG. 1 depicts a conceptual structure and information flow among entities implementing memory pointer increment for a non-CHERI enabled CPU in accordance to prior art;

FIG. 2 depicts a conceptual structure and information flow among entities implementing memory pointer incrementation for a CHERI enabled CPU in accordance with prior art; and

FIG. 3 depicts a conceptual structure and information flow among entities implementing memory pointer incrementation for a CHERI enabled CPU in accordance with an aspect of this disclosure.

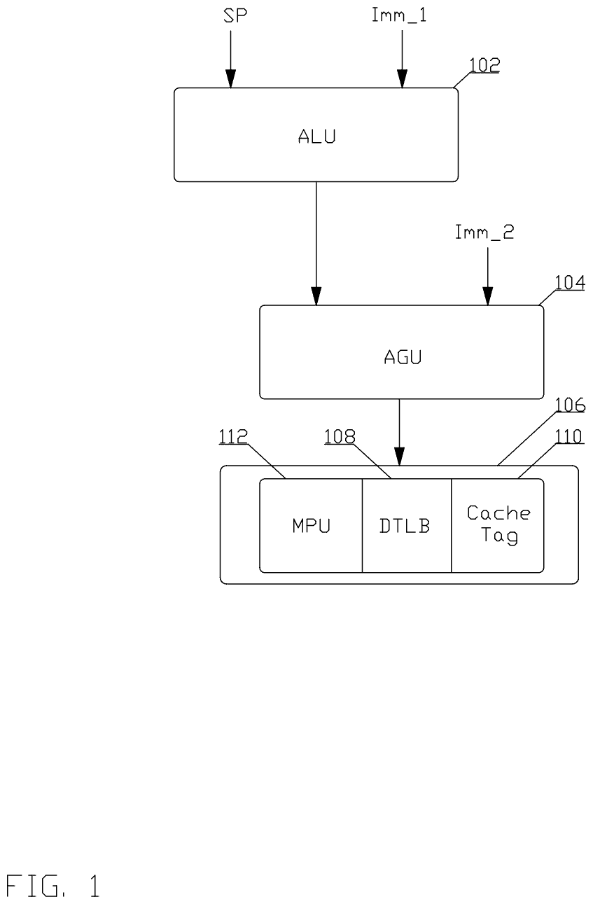

### DETAILED DESCRIPTION

Unless otherwise defined, all terms (including technical and scientific terms) used herein have the same meaning as commonly understood by a person having ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a”, “an”, and “the”, are intended to include the plural forms as well, unless the context clearly indicates otherwise. It will be further understood that the terms “comprise”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Various disclosed aspects may be illustrated with reference to one or more exemplary configurations. As used herein, the term “exemplary” means “serving as an example, instance, or illustration,” and should not necessarily be construed as preferred or advantageous over other configurations disclosed herein.

Various aspects of the present invention will be described herein with reference to drawings that are schematic illustrations of conceptual configurations of the present invention, unless explicitly noted. The various aspects of this disclosure are provided to enable a person having ordinary skill in the art to practice the present invention. Modifications to various aspects as presented throughout this disclosure will be readily apparent to a person having ordinary skill in the art, and the concepts disclosed herein may be extended to other applications.

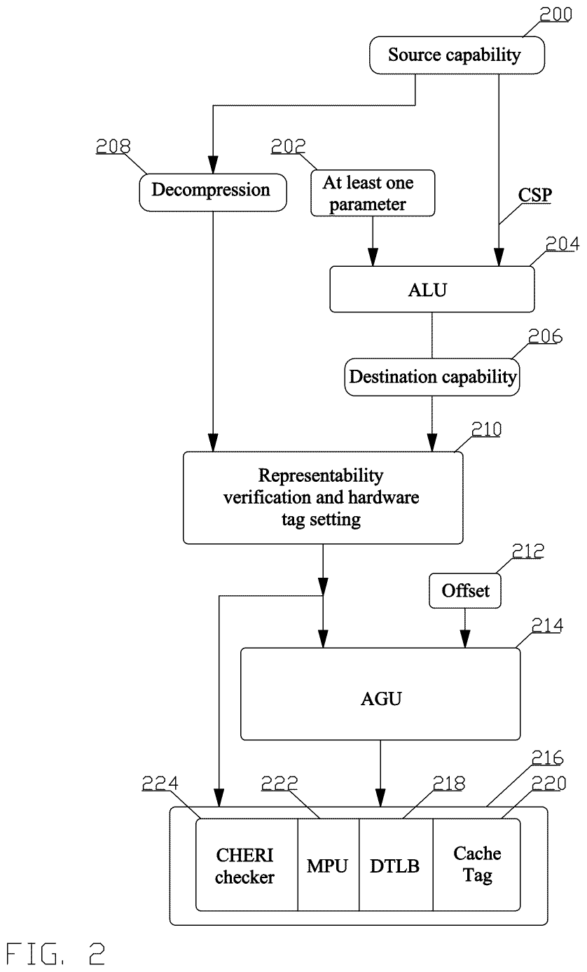

Referring back to FIG. 2, the inventor realized that with the exception of rare cases, e.g., during debugging of program code, execution of an improperly debugged corner case or an edge case of some program code, or targeted exploit, the address in the address field of the destination capability to be forwarded from the ALU 204 for processing by a subsequent instruction, e.g., the L/S instruction as shown, is within the representable range of addresses of the source capability, as verified by the representable permission block 210. Therefore, the result of addition by the subsequent instruction, e.g., the exemplary CADDI instruction as shown, can be provided immediately after completing the ALU's 204 calculation, i.e., in a single clock cycle, and the representable permission verification of block 210 of FIG. 2 can be postponed to the next clock cycle, thus not requiring either reduction of the clock frequency of the central processing unit (CPU) to extend the clock cycle or an addition of an extra clock cycle before forwarding the resulting capability. Such a forwarding is termed speculative forwarding, since the correct value of the capability verification tag is not known; it is speculated to be correct.

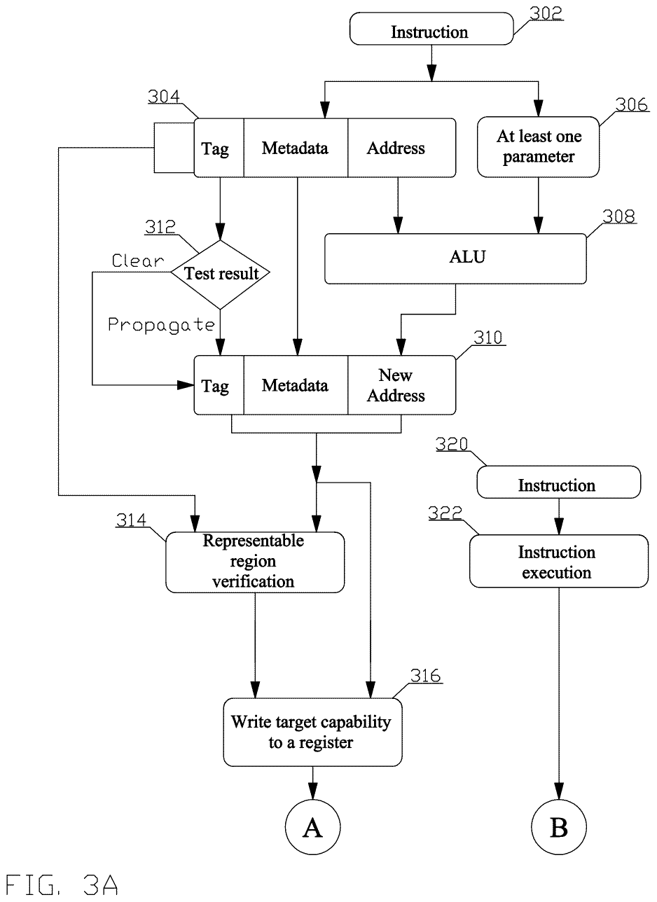

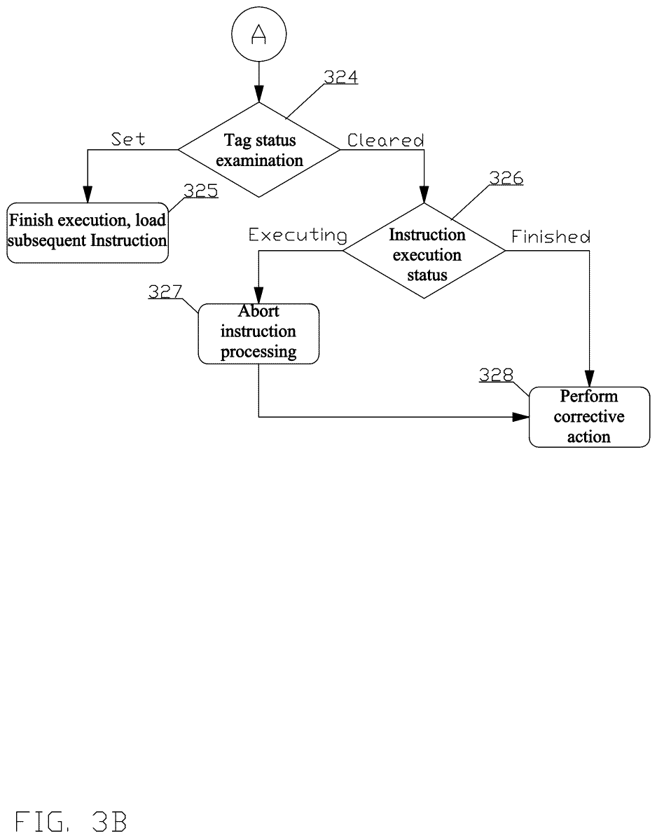

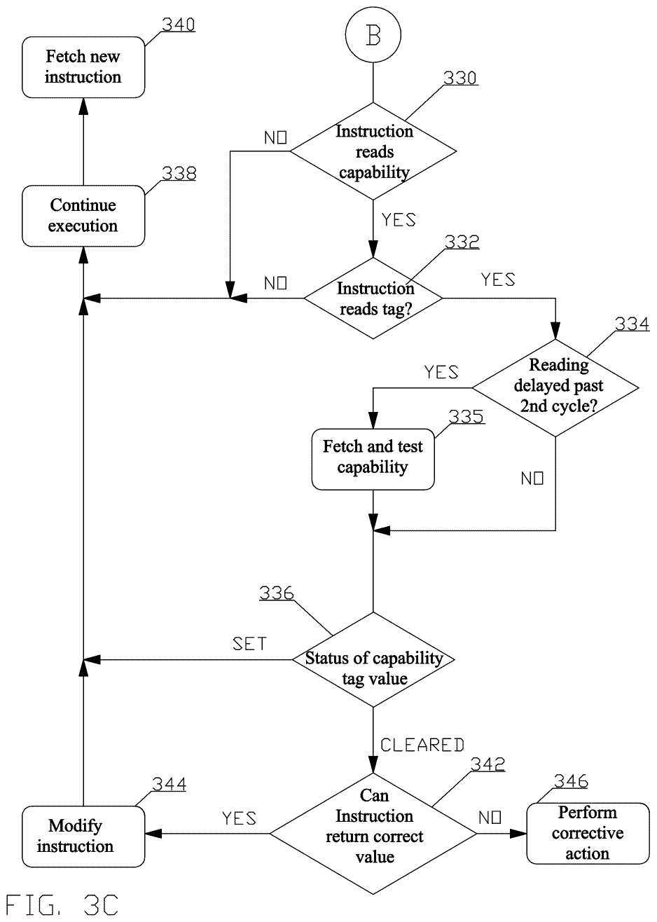

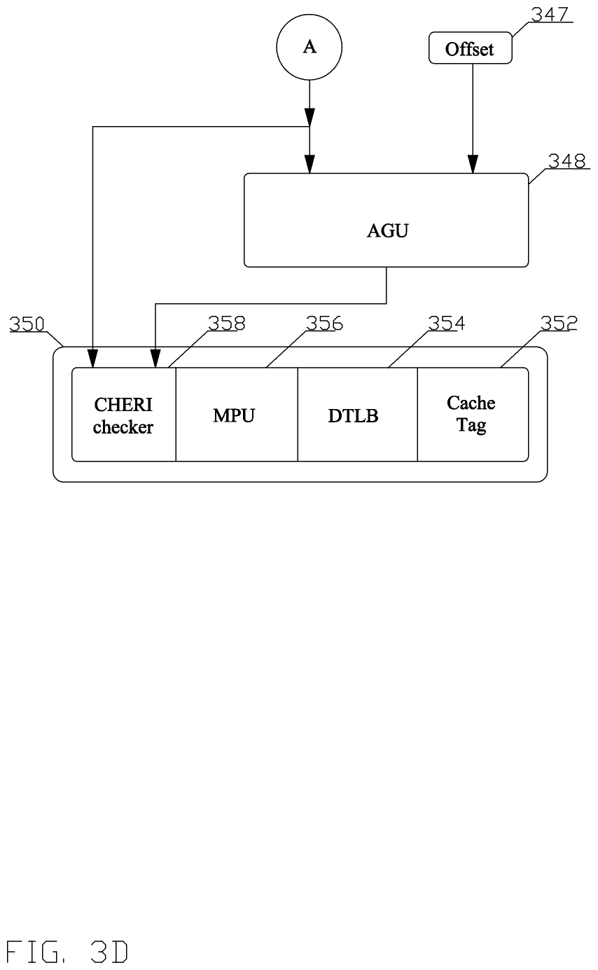

Such modification is disclosed in FIG. 3 depicting a conceptual structure and information flow among elements of the conceptual structure implementing memory pointer incrementation for a CHERI enabled CPU in accordance with an aspect of this disclosure. The elements comprise hardware or software entities implementing the blocks and/or the block's functionality. Such a memory pointer incrementation is performed by one of the above-noted CHERI instructions that accepts a capability as one of its inputs and modifies the address of the capability while requiring the representable range verification.

Referring to FIG. 3a, in a first clock cycle, a CHERI instruction 302 that accepts a capability as one of its inputs and modifies the address in the address field, that requires representable range verification, is fetched from a pipeline (not shown).

The CHERI instruction 302 accepts a source capability 304 to be used as one of its input parameters, together with at least one additional parameter 306. The source capability 304 can be provided by the preceding instruction or fetched from a register. In the latter case, since it is possible that the source capability 304 is corrupted upon having been fetched from a register, the CADDI instruction requires that the source capability 304 is tested for being sealed against software modification or for a corruption, e.g., whether bounds were malformed, any reserved metadata bits were set, i.e., metadata bits that are reserved for future use and therefore must not be set. Therefore, source capability 304 is tested in block 312, and in response to the test result indicating that the source capability 304 is not corrupted, and is not sealed, the source capability's 304 validity tag is propagated; in response to the test result indicating the capability's 304 corruption, or being sealed to prevent software modification, the source capability's 304 validity tag is cleared by a dedicated hardware or a software entity (not shown).

In one aspect of the invention, upon clearing the source capability's 304 validity tag, the processing continues by providing the source capability's 304 address and at least one additional parameter 306 to the ALU 308, which calculates a new address. The new address, the metadata and the capability verification tag from the source capability 304 are provided to a destination capability 310, upon completion of which the capability verification tag is forwarded. However, since the source capability 304 is corrupted or sealed, the representable range verification in block 314 is skipped. The capability 310 is written to the register 316 and forwarded to the instruction 320; consequently, the processing of the forwarded capability 310 verification tag continues as described in FIG. 3b and associated text or FIG. 3c and associated text infra.

In another aspect of the invention, upon clearing the source capability's 304 verification tag, the processing continues in the same manner as if the test were not required and as such not performed. By providing the source capability's 304 address and at least one additional parameter 306 to the ALU 308, which calculates a new address. The new address, the metadata and the capability verification tag from the source capability 304 are provided to a destination capability 310. Since the processing of the destination capability 310 with the correct tag status continues in the same manner as the processing of a destination capability with a tag status, a correctness of which is not known, the destination capability 310 is considered to be speculatively forwarded.

Since all the CHERI instructions that accept a capability as one of the instructions'inputs and modify the address in a manner requiring a representable range verification take less than or one clock cycle to perform the potentially required tests and the modification to the address, all these operations occur in the first clock cycle.

In the second clock cycle the execution of the CHERI instruction 302 continues by providing the source capability 304 and the speculatively forwarded destination capability 310 to a representable range verification block 314, which verifies whether the new address of destination capability 310 is within the representable range defined by the metadata and the address of the source capability 304 or not. The verification occurs in the second clock cycle.

Upon finishing the verification, the representable range verification block 314 reevaluates the status of the speculatively forwarded capability verification tag. Should the verification succeed, the destination capability 310 including the speculatively forwarded capability verification tag, the new address, and the metadata, is written to the register in block 316. The status of the capability verification tag may have been cleared regardless of whether the representable range verification is successful or fails due to the source capability 304 potential corruption, or being sealed against software modification, as described supra.

Should the verification fail, the representable range verification block 314 tests the status of the speculatively forwarded capability verification tag and in response to the status already being cleared, the destination capability 310 including the cleared speculatively forwarded capability verification tag, the new address, and the metadata is written to a register in block 316. Otherwise in response to the status being set, representable range verification block 314 clears the speculatively forwarded capability verification tag and the destination capability 310 including the cleared speculatively forwarded capability verification tag, the new address, and the metadata is written to a register in block 316. This reevaluation depends on the timing, it may occur in the second or later clock cycle.

In the same second clock cycle, in parallel with the verification processing in block 314, an instruction 320 is fetched from the pipeline, and the instruction 320 execution begins in block 322. The processing of the instruction 320, may or may not be finished by the end of the second clock cycle, due to the fact that some instructions are multi-clock cycle instructions.

Postponing the verification of the address of the destination capability to the second clock cycle solves the pointer increment slowdown because the instruction 320 execution begins in the second clock cycle in block 322 without waiting for the result of the verification. The correct value of the speculatively forwarded capability verification tag may not be known at the time of the instruction 320 execution during the second clock cycle, except in cases when the capability verification tag was cleared due to the bounds being malformed, any reserved bits being set or the capability was sealed. Consequently, there are several possibilities regarding further processing.

Referring to FIG. 3b, in one aspect of the invention, once the result of the representable range verification, indicated by the value of the capability verification tag, is known within the second clock cycle, the status of the capability verification tag is examined in block 324.

As demonstrated supra, in most of the cases, the source capability 304 is not corrupted and the destination capability 310 succeeds the representable range verification indicated by the capability verification tag being set; consequently, the currently executing program execution continues in block 325, either by continuing executing instruction 320, in case the execution has not finished or the instruction 320 is a multi-clock cycle instruction, or by loading a subsequent instruction.

In the rare cases of the source capability 304 being corrupted, being sealed to prevent software modification and/or the destination capability 310 having failed the representable range verification indicated by the capability verification tag being cleared; thus, indicating a potential security problem with the currently executing program, the status of the execution of the instruction 320 is ascertained in block 326, regardless of the type of the instruction 320, or any subsequent instruction should the subsequent instruction execution also have started in the second cycle. Should the result of block 326 indicate that execution of the instruction 320 or any subsequent instruction is still in progress, block 327 aborts the execution of the second or subsequent instructions and the processing continues in block 328.

Should the result of block 326 indicate that execution has finished, in an aspect of the invention for any instruction, since the source capability 304 and/or the destination capability 310 contains incorrect data as established by the capability verification tag being cleared, it is a general principle of processor design to perform a corrective action. Consequently, block 327 causes the pipeline to be flushed and reloaded with the instruction 320, as well as any subsequent instruction(s) already executed or in a process of being executed, and re-execute these instructions. Since the capability verification tag associated with execution of the source instruction 302 and/or the destination instruction 310 has been cleared, re-execution of the instruction 320 and any subsequent instructions cause the re-executed instruction(s) to read the correct data, i.e., the cleared capability verification tag value.

Alternatively, execution of an instruction depends on an occurrence of several events, i.e., type and characteristic of the instruction, timing of the representable range verification and subsequent verification of the speculatively forwarded capability verification tag vis-a-vis the execution of the instruction, and other events. Based on the type and characteristics of the instruction, there are three classes of instruction to consider.

The first class comprises instructions that read both a capability and the capability's verification tag. The term read is understood to mean to use a destination capability as at least one of the instruction's parameters, and to consider the capability's verification tag.

The second class comprises instructions that read a destination capability, but do not read, i.e., require consideration of the destination capability's verification tag. By means of example, such instructions may, only inspect the address; use the address for a different purpose, e.g., extract the base memory bound-an action that does not require a capability's verification tag consideration, e.g. the CHERI RISC-V instruction GCBASE, or assembling the capability and authorising the assembled capability by another capability, which may have larger bounds and/or permissions e.g. the CHERI RISC-V instruction CBLD. Such instructions may extract one or more field from the capability's metadata, such as permissions, e.g., the CHERI RISC-V instruction GCPERM.

The third class comprises instructions that do not read a capability.

Furthermore, regardless of the class of an instruction, some instructions do not require testing whether the capability used as an input to the instruction was correctly formed and/or correctly retrieved from a register to be performed.

Referring to FIG. 3c, these classes are considered. Consider an instruction 320, an execution of which is subsequent to an execution of the instruction 310. To distinguish among the different classes of instruction, decision block 330 evaluates whether the instruction 320 reads a capability. In response to a negative decision block 330, the instruction 320 that does not read a capability and, consequently, does not need information about the validity of the capability's verification tag. Therefore, the execution continues in block 338 and the currently executing program continues by fetching the next instruction in the clock cycle following the end of the instruction 320 execution in block 340.

In response to the positive decision in block 330, block 332 evaluates whether the instruction 320 reads a capability verification tag. In response to a negative decision in block 332, the value of the capability's verification tag is immaterial, and the execution continues in block 338 and the currently executing program continues by fetching the next instruction in the clock cycle following the end of the instruction 320 execution in block 340.

In response to a positive decision in block 332, block 334 determines whether the reading of the destination capability's 310 verification tag by instruction 320 is delayed from starting in the second cycle, because an instruction processing depends on the timing between the destination capability's 310 verification, which causes the subsequent reevaluation of the speculatively forwarded capability verification tag value, and the time when an instruction reads the destination capability's 310 verification tag. Consider that such an instruction comprises, e.g., the instruction 320, the execution of which is being delayed to a subsequent clock cycle, by, e.g., a pipeline stall, the instruction's 320 cache miss, or other events known to a person of ordinary skill in the art. Alternatively, although the instruction 320 starts execution in the second clock cycle, the instruction 320 does not read the destination capability's 310 verification tag, however, a subsequent instruction does read the destination capability's 310 verification tag in the third or later cycle from the register 316. Consequently, since the capability's verification tag status is known at the end of the second clock cycle, therefore, either the delayed instruction 320 or the subsequent instruction can be processed according to the reevaluated capability's verification tag status as disclosed infra.

In response to the determination in block 334 that the instruction 320 reads the destination capability's 310 verification tag in the second clock cycle, i.e., the speculatively forwarded verification tag in parallel with the representable range verification and, furthermore, the speculatively forwarded tag of the destination capability 310 is provided to decision block 336.

In response to the determination in block 336 that the speculatively forwarded capability verification tag was set, the execution of the instruction 320 continues in block 338, and the currently executing program continues by fetching the next instruction in the clock cycle following the end of the instruction 320 execution, cf. block 340.

In response to the determination in block 336 that the speculatively forwarded capability verification tag was cleared, the instruction 320 is examined to determine whether the instruction 320 can be modified to return a corrected value in block 342. The term correct value is understood as modifying the instruction's return value regardless of the instruction's input parameters being correct or not. In response to the determination in block 342 being positive, it is possible to modify the result of the instruction 320 in block 344, e.g., by modifying the capability verification tag to the value determined by the representable range verification block 316 for GCTAG which returns an integer value representing the capability verification tag value, or for CADDI which returns a capability, which will have its capability verification tag cleared. The instruction is modified in block 344 and execution of the modified instruction 320 continues in blocks 338 and 340. In response to the determination in block 342 being negative, the instruction 320 cannot be modified to return a correct value, and block 346 performs corrective action.

In one aspect of the invention, the block 346 performs corrective action by causing the pipeline to be flushed and reloaded with the instruction 320, as well as any subsequent instructions, and re-execute these instructions as described in regards to block 327 supra.

In another aspect of the invention, applicable only to instructions accessing a memory, e.g., an L/S instruction, an additional means of correcting the action exists, as depicted in FIG. 3d. Such a memory accessing instruction takes as input the destination capability 310 supra, and an offset 347 between the destination capability 310 address and the actual L/S address to access. The offset 347 is provided by the currently executing program or is embedded in the instruction. The L/S instruction instructs an address generation unit (AGU) 348 to calculate the L/S virtual address from the address of the destination capability and the offset 347. In one aspect, the AGU 348 replaces the address in the destination capability with the L/S virtual address and provides the destination capability 310 to the LSU 350. In another aspect, the AGU 348 provides the L/S virtual address to the LSU 350. The AGU 348 operation occurs in a single clock cycle.

The LSU 350 comprises a Data Translation Lookaside Buffer (DTLB) 354, a cache tag (CT) 352 buffer, a memory protection unit (MPU) 356; the structures as described supra and a CHERI checker 358. For the CHERI enabled CPU, the MPU 356 comprises physical memory attributes (PMA) unit and an optional physical memory protection (PMP) unit. The PMA unit contains information of the physical memory/memories existing in the system, e.g., cached memory, device memory, and other memories known to a person of ordinary skill in the art. The PMP unit defines a finite number of regions, which can be individually configured to enforce access permissions to a range of addresses in the physical memory in the system. The CHERI checker 358 performs checks on a memory access by using a capability, e.g., whether the L/S address is in-bounds, the value of the capability verification tag, and other checks known to a person of ordinary skill in the art.

Upon receiving both the destination capability 310 and the L/S virtual address from the AGU 348, cf. FIG. 3a, the CHERI checker 358 performs a check of the representable range verification indicated by the status of the capability verification tag. If the representable range verification failed, the CHERI checker 358 generates an exception, returning capability verification tag failure. The exception is processed by an exception handler at the CPU, which performs a process specified by the CPU architecture for the specific instruction and exception type, i.e., the L/S instruction as described and a capability verification tag failure.

A person of ordinary skill in the art will understand that the LSU 350 as depicted and described is not the only implementation. By means of an example, if the address provided by the AGU 348 is a physical address, the translation by the DTLB 354 is unnecessary. In such cases either the DTLB 354 is not implemented, or the DTLB 354 is bypassed.

Should the capability verification tag be propagated, the LSU 350 processes the input parameters as described in the CHERI specification, and thus known to a person of ordinary skill in the art.

In response to the determination in block 334 that the instruction's 320 reading of the destination capability's 310 verification tag has been delayed to a third or later clock cycle, or that the execution did not start until a third or later clock cycle, since the representable range verification concluded and register 316 now contains the fully tested destination capability 310 including the reevaluated capability verification tag, the instruction 320 fetches the destination capability 310 from the register in block 316. Should the instruction's 320 specification require testing to determine whether the destination capability 310 is corrupted or not as disclosed supra, such testing is performed by block 335. The capability verification tag either propagated in case that all the tests succeed, or trivially cleared in case that at least one test fails, is provided to the decision block 336 and the instruction 320 execution continues according to the result of the decision in block 336 as described supra.

The various aspects of this disclosure are provided to enable a person having ordinary skill in the art to practice the present invention. Various modifications to these aspects will be readily apparent to persons of ordinary skill in the art, and the concepts disclosed therein may be applied to other aspects without departing from the spirit or scope of the invention. Thus, the present invention is not intended to be limited to the aspects shown herein but is to be accorded the widest scope consistent with the principles and novel features disclosed herein.

Therefore, by means of an example a person having ordinary skill in the art will understand, that the flow chart is not meant to be interpreted as an implementation, but rather at a level enabling explanation of the inventive concepts. Furthermore, certain steps may be added or be unnecessary and/or may be carried out in parallel based on a particular implementation. By means of an example, there is no need to test whether an instruction reads a capability, but rather only whether the instruction reads the capability's verification tag, the two decision blocks were shown to understand the different classes of instructions.

All structural and functional equivalents to the various illustrative logical blocks, modules, circuits, and algorithm steps described in connection with the various aspects described throughout this disclosure that are known or later come to be known to those of ordinary skill in the art are expressly incorporated herein by reference and are intended to be encompassed by the claims. Such illustrative logical blocks, modules, circuits, and algorithm steps may be implemented as electronic hardware, computer software, or combinations of both. That is, as described supra, since the CHERI extends the capability of the CPU, such extension is accomplished by adding dedicated hardware embodying the added CHERI functionality, e.g., testing the source capability for being sealed or corrupted, forwarding the capability verification tag, and other such added CHERI functionality known to a person of ordinary skill in the art, together with both firmware and software support.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for an efficient capability verification tag forwarding for a Capability Hardware Enhanced RISC Instructions (CHERI) enabled Central Processing Unit, comprising:
executing a first instruction manipulating an address of a source capability resulting in a destination capability in a first clock cycle;
speculatively forwarding the capability verification tag of the destination capability in the first clock cycle;
verifying an integrity of the destination capability's address in a second clock cycle;
starting execution of a second instruction in the second clock cycle in parallel with the verifying; and
reevaluating the status of the speculatively forwarded the capability verification tag in response to the verifying.

2. The method as claimed in claim 1, further comprising:
determining a status of the destination capability verification tag; and
in response to the determining status being cleared:
flushing an instruction pipeline;
reloading the instruction pipeline with the second instruction and any additional subsequent instruction(s) already executed or in a process of being executed; and
re-executing the second instruction and the any additional subsequent instruction(s).

3. The method as claimed in claim 1, further comprising:
determining whether the second instruction reads the destination capability verification tag; and
continuing processing the second instruction in response to the determining being negative.

4. The method as claimed in claim 3, further comprising:
determining a status of the destination capability verification tag in response to the determining being positive; and
continuing execution of the second instruction in response to the determining that the status is set.

5. The method as claimed in claim 4, wherein response to the determining that the status is cleared further comprising:
determining whether the second instruction reads the destination capability verification tag past the second cycle; and
in response to the determining being negative:
determining whether the second instruction can be modified to return a correct value in response to the determining that the status is cleared;
modifying the second instruction in response to the determining that the second instruction can be modified; and
continuing the execution of the modified second instruction.

6. The method as claimed in claim 5, wherein in response to the determining the status of the second instruction cannot be modified to return a correct value further comprising:
flushing an instruction pipeline;
reloading the instruction pipeline with the second instruction and any subsequent instruction(s) already executed or in a process of being executed; and
re-executing the second instruction and the any subsequent instruction(s).

7. The method as claimed in claim 5, wherein in response to the determining that the subsequent instruction cannot be modified to return a correct value further comprising:
determining that the second instruction is a memory accessing instruction;
providing the destination capability verification tag to a CHERI checker at a load/store unit; and
generating an exception.

8. The method of claim 5, wherein in response that the second instruction does not read the destination capability verification tag past the second cycle further comprising:
determining a status of the reevaluating the destination capability verification tag; and
continuing execution of the second instruction in response to the determined status.

9. The method as claimed in claim 1, further comprising:
testing the source capability for being sealed or corrupted; and
clearing the capability verification tag of the source capability in response to the test being positive.

10. The method as claimed in claim 9, wherein in response to the test being positive further comprising:
performing only the steps of executing an instruction manipulating an address of a source capability resulting in a destination capability in a first clock cycle; and
forwarding the capability verification tag of the destination capability in the first clock cycle.

11. An apparatus for an efficient capability verification tag forwarding for a Capability Hardware Enhanced RISC Instructions (CHERI) enabled Central Processing Unit, comprising:
a Central Processing Unit configured to:
execute a first instruction manipulating an address of a source capability resulting in a destination capability in a first clock cycle;
speculatively forward the capability verification tag of the destination capability in the first clock cycle;
verify an integrity of the destination capability's address in a second clock cycle;
start execution of a second instruction in the second clock cycle in parallel with the verifying; and
reevaluate the status of the speculatively forwarded the capability verification tag in response to the verifying.

12. The apparatus as claimed in claim 11, wherein the Central Processing Unit is further configured to:
determine a status of the destination capability verification tag; and
in response to the determining status being cleared:
flush an instruction pipeline;
reload the instruction pipeline with the second instruction and any additional subsequent instruction(s) already executed or in a process of being executed; and
re-execute the second instruction and the any additional subsequent instruction(s).

13. The apparatus as claimed in claim 11, the Central Processing Unit is further configured to:
determine whether the second instruction reads the destination capability verification tag; and
continue processing the second instruction in response to the determining being negative.

14. The apparatus as claimed in claim 13, wherein the Central Processing Unit is further configured to:
determine a status of the destination capability verification tag in response to the determining being positive; and
continue execution of the second instruction in response to the determining that the status is set.

15. The apparatus as claimed in claim 14, wherein in response to the determination that the status is cleared the Central Processing Unit is further configured to:
determine whether the second instruction reads the destination capability verification tag past the second cycle; and
in response the determining being negative:
determine whether the second instruction can be modified to return a correct value in response to the determining that the status is cleared;
modify the second instruction in response to the determining that the second instruction can be modified; and
continue the execution of the modified second instruction.

16. The apparatus as claimed in claim 15, wherein in response to the determining the status of the second instruction cannot be modified to return a correct value the Central Processing Unit is further configured to:
flush an instruction pipeline;
reload the instruction pipeline with the second instruction and any subsequent instruction(s) already executed or in a process of being executed; and
re-execute the second instruction and the any subsequent instruction(s).

17. The apparatus as claimed in claim 5, wherein in response to the determining that the subsequent instruction cannot be modified to return a correct value the Central Processing Unit is further configured to:
determine that the second instruction is a memory accessing instruction;
provide the destination capability verification tag to a CHERI checker at a load/store unit; and
generate an exception.

18. The apparatus of claim 15, wherein in response that the second instruction does not reads the destination capability verification tag past the second cycle the Central Processing Unit is further configured to:
determine a status of the reevaluating the destination capability verification tag; and
continue execution of the second instruction in response to the determined status.

19. The apparatus as claimed in claim 1, wherein the Central Processing Unit is further configured to:
test the source capability for being sealed or corrupted; and
clear the capability verification tag of the source capability in response to the test being positive.

20. The apparatus as claimed in claim 19, wherein in response to the test being positive the Central Processing Unit is further configured to:
perform only the steps of execute a first instruction manipulating an address of a source capability resulting in a destination capability in a first clock cycle; and
forward the capability verification tag of the destination capability in the first clock cycle.
